(19) United States
(12) Patent Application Publication
(10) Pub. No.: US 2021/0304252 A1
(43) Pub. Date: Sep. 30, 2021

(54) SYSTEM AND METHOD FOR AUTOMATICALLY DELIVERING CRITERION-DRIVEN MESSAGING

(71) Applicant: 9378-7570 QUEBEC INC D.B.A. WINK.LOVE, Verdun (CA)

(72) Inventors: Nola LEBLANC, Chambly (CA); Yves GAUDREAULT, Montreal (CA); Ivan Junior MILLETTE, Blainville (CA)

(73) Assignee: 9378-7570 QUEBEC INC D.B.A. WINK.LOVE, Verdun (CA)

(21) Appl. No.: 17/264,358

(22) PCT Filed: Aug. 1, 2018
(86) PCT No.: PCT/CA2018/050943

§ 371 Date: Jan. 29, 2021

(51) Int. Cl. G06Q 30/02; H04L 29/06

(52) U.S. Cl. CPC G06Q 30/0261; H04L 2463/102; H04L 63/08; G06Q 30/0236

(57) ABSTRACT

In one embodiment, the present invention provides systems and methods for sending an electronic communication over an electronic communication network, the method including the steps of receiving an electronic communication from a first user device, the electronic communication including an at least one predetermined delivery criterion and associated with at least a second user device, the at least a second user device associated with a respective at least a second user, the electronic communication sent from a first user device to a central database over the electronic communication network, storing the electronic communication in a first user account associated with the first user and stored on the central database and automatically sending the electronic communication to the at least a second user device over the electronic communication network upon satisfaction of the at least one predetermined delivery criterion.

### FIELD

The present invention relates to systems and methods for electronic messaging in a social networking environment. More specifically, the present invention relates to a system and method for automatically delivering an electronic message upon the satisfaction of at least one predetermined criterion and managing the delivery and message history of previously sent electronic communications in the context of a social network provided over an electronic communication network.

### BACKGROUND

Method and systems for composing, sending, receiving and managing electronic messages are well known and given the proliferation of mobile device and “smartphone” ownership, these known methods are commonly used by a significant proportion of society.

For example, electronic mail (commonly known as “e-mail”) provides the ability for a first user to send an electronic message (in a variety of formats) to a second user by way of two computing devices connected through an electronic communication network. Generally speaking, electronic messages sent via email are composed using standard protocols, have a “header” and a “message body” and are typically “host” agnostic in that they can be sent and received by users who are employing different software programs to manage (i.e.: “host”) their email accounts. Hosted email accounts can often be accessed in a variety of ways including: through a web browser, via a mobile software application, through an enterprise desktop software program, etc. As such, a user can send an email to any other user who also has an email address.

Similarly, “instant” messages (also known as direct or personal messages) can be sent from a first user to a second user by way of two computing devices connected through an electronic communication network. Instant messages differ from email in that they are brief and typically sent via a proprietary software application that is format specific. In fact, it will be appreciated that many social networking services and instant messaging providers have proprietary formats and as such instant messages tend to be platform specific. As such, a user can only send an instant message to another user of the same platform.

In a cellular network context, users can also send “text” messages to other users who are connected to any cellular network through their mobile phone accounts. Text messaging is similar to instant messaging in that the message content is typically brief (and often limited), however text messaging is similar to email in that it is host agnostic—a user can send a text message to any other user who also has a mobile phone number, regardless of service provider or the software that they use to compose and manage their text messages.

However, the skilled person will appreciate that the aforementioned systems and methods for sending and receiving text messages are limited in the ability to provide control over the sending and receiving of electronic communication based on the occurrence of predetermined delivery criteria.

Moreover, it will also be appreciated that the aforementioned systems and methods do not necessarily provide a manner in which a first user can send a targeted promotion or offer to a second user within an electronic communication such that the second user will receive the targeted promotion upon the occurrence of predetermined delivery criteria.

Finally, it will be appreciated that many of the aforementioned methods and systems do not provide a manner for managing the delivery and message history of previously sent electronic communications in the context of a social network provided over an electronic communication network.

Therefore, what is needed is methods and systems for automatically delivering an electronic message upon the satisfaction of at least one predetermined delivery criterion, providing the opportunity to send a targeted promotion to a second user within an electronic communication such that the second user will receive the targeted promotion upon the occurrence of predetermined delivery criteria and managing the delivery and message history of previously sent electronic communications in the context of a social network provided over an electronic communication network.

### BRIEF SUMMARY

It is contemplated that the present invention can provide methods and systems for automatically delivering an electronic message upon the satisfaction of at least one predetermined delivery criterion, providing the opportunity to send a targeted promotion to a second user within an electronic communication such that the second user will receive the targeted promotion upon the occurrence of predetermined delivery criteria and managing the delivery and message history of previously sent electronic communications in the context of a social network provided over an electronic communication network.

In one embodiment, the present invention provides systems and methods for sending an electronic communication over an electronic communication network, the method including the steps of receiving an electronic communication from a first user device, the electronic communication including an at least one predetermined delivery criterion and associated with at least a second user device, the at least a second user device associated with a respective at least a second user, the electronic communication sent from a first user device to a central database over the electronic communication network, storing the electronic communication in a first user account associated with the first user and stored on the central database and automatically sending the electronic communication to the at least a second user device over the electronic communication network upon satisfaction of the at least one predetermined delivery criterion.

### DESCRIPTION OF THE FIGURES

The present invention will be better understood in connection with the following Figures, in which:

FIG. 1 is a diagram of a suitable user device for use in accordance with the present invention;

FIG. 2 is a diagram of two suitable user devices in electronic communication over an electronic communication network in accordance with the present invention;

FIG. 3 is a diagram of one embodiment of a method in accordance with the present invention;

FIG. 4 is a diagram of another embodiment of a method in accordance with the present invention;

FIG. 5 is a diagram of yet another embodiment of a method in accordance with the present invention; and

FIG. 6 is a diagram of yet another embodiment of a method in accordance with the present invention.

### DETAILED DESCRIPTION OF EMBODIMENTS

It is contemplated that the present invention can provide methods and systems for automatically delivering an electronic message upon the satisfaction of at least one predetermined delivery criterion, providing the opportunity to send a targeted promotion to a second user within an electronic communication such that the second user will receive the targeted promotion upon the occurrence of predetermined delivery criteria and managing the delivery and message history of previously sent electronic communications in the context of a social network provided over an electronic communication network.

In the context of the present invention, it will be appreciated that an “electronic communication” can include any suitable method of electronic communication including but not limited to a text message, audio message, video message, image message and an electronic mail (email). Moreover, it is contemplated that a suitable electronic communication can include any suitable electronic information or data including but not limited to text, images, videos, audio files, electronic documents and web or hyperlinks.

In the context of the present invention, it will be appreciated that “predetermined delivery criteria” (or, singularly, a predetermined delivery criterion) can include but is not limited to geolocation-based delivery criteria, time-based delivery criteria, date-based delivery criteria and event-based delivery criteria.

In the context of the present invention, it will be appreciated that a “user device” can be any suitable electronic user device that can provide connectivity with other analogous user devices over an electronic communications network. It is contemplated that a suitable user device can be any suitable device such as but not limited to a computing device or mobile devices such as smartphones or cellular telephones, as discussed herein.

Moreover, it is contemplated that a suitable user device will have suitable input means (including but not limited to a keyboard, touchscreen, microphone and/or camera) for inputting or composing a suitable electronic communication and sending the electronic communication over an electronic communication network to a connected second user.

In the context of the present invention, it will be appreciated that an “electronic communication network” can be any suitable electronic network including a regional cellular network, a local wi-fi network, a global satellite network or simply two user devices in suitable near field communication (NFC).

In the context of the present invention, it will be appreciated that a “central distribution server” can be any suitable type of computer server (or multiple servers suitably connected) that is capable of hosting and running the requisite server, including but not limited to enterprise servers and cloud-computing arrangements, among any other suitable server arrangements that will be readily appreciated by the skilled person.

User-to-User Networked Messaging

In at least one embodiment, it is contemplated that the present invention provides methods and systems adapted for sending electronic communications over an electronic communication network through a central distribution server.

In at least one embodiment, the present method is initiated when a first user creates a first user account by accessing a database hosted on the central distribution server through a first user device over an electronic communication network. It is contemplated that the first user can access the database (and the central distribution server) through an internet browser, through a mobile software application or through a thin-client software application, among any other suitable methods for accessing a central distribution server and database over an electronic communication network that will be readily appreciated by the skilled person.

The first user account can include a variety of information associated with the first user including personal identification information and data, passwords, banking information and account information obtained from an associated social network account (such as but not limited to Facebook®, Twitter®, LinkedIn® and Gmail®). In some embodiments it is contemplated that a user account can include contact information for other current and potential social network users.

After a first user account has been created, it is contemplated that in some embodiments the first user may need to authenticate an associated first user device that is in electronic communication with the central distribution server over the electronic communication network.

In these embodiments, it is contemplated that the first user will need to verify the first user's and/or the first user device's identity and confirm an association with the first user account. The skilled person will readily appreciate that authentication can be achieved in any number of ways including, but not limited to, entering and confirming a previously selected password, obtaining and verifying personal information, obtaining and verifying biometric information and prompting and obtaining a response to a skill-testing question.

It is also contemplated that multifactor identification confirmation methods can be used to confirm the identity of and therefore authenticate the first user and/or the first user device.

Next, in some embodiments it is contemplated that the first user may need to invite or connect with a second user who the first user wishes to communicate with over the electronic communication network. This invitation or connection can be achieved in any number of ways. In some embodiments, it is contemplated that an invitation can be sent directly from the first user device to a second user through the central distribution server. In other embodiments, it is contemplated that the first user can invite the second user to connect by way of email, text message or any other suitable and known method of electronic communication.

It is also contemplated that suitable contact information can be directly imported into the first user's account based on a pre-existing social media account, such as but not limited to Facebook®, Twitter®, LinkedIn® and Gmail® or the user's personal contact list stored on the user's mobile device.

In embodiments where the second user is invited to connect with the first user over the electronic communication network through the central distribution server, it is contemplated that the second user will also be required to create a second user account that is stored on the database in a manner that is otherwise analogous to the process of creating the first user account as discussed herein, and similarly the second user account can be considered analogous to the first user account.

Once the first user and the second user are suitably connected over the electronic communication network through the central distribution server, it is contemplated that the first user can compose a suitable electronic message for sending to the second user over the electronic communication network through the central distribution server.

As discussed herein, it is contemplated that a suitable electronic communication can take any number of forms, including but not limited to an email message, video message, audio/voice message, photo message and text message and it is further contemplated that an electronic communication can include any suitable information or content, including but not limited to graphics, text, audio, hyperlinks, photos, videos, embedded electronic documents and scannable codes (such as but not limited to QR or UPC codes).

It is contemplated that an electronic communication includes at least one predetermined delivery criterion. As discussed herein, it is contemplated that the predetermined delivery criterion can take a number of forms (including but not limited to geolocation-based delivery criteria, time-based delivery criteria, date-based delivery criteria and event-based delivery criteria) and that the electronic communication will be automatically sent (or, analogously, pushed) to the second user device upon satisfaction of the at least one predetermined delivery criterion.

In the intervening period before the electronic communication is automatically sent to the second user device upon satisfaction of the predetermined delivery criterion, it is contemplated that the electronic communication is stored in a database hosted by the central distribution server. It is further contemplated that the first user can track and access the stored electronic communication during this period through the associated first user account. Furthermore, should the first user wish to cancel or modify the electronic message, it is contemplated that the present method and systems provide means for accomplishing these tasks.

Once the predetermined delivery criterion is satisfied, it is next contemplated that the electronic communication is automatically sent to the second user device through the central distribution server over the electronic communication network.

Once the electronic message is automatically sent, in some embodiments it is contemplated that a confirmation message is automatically sent to the first user device through the central distribution server over the electronic communication network. Moreover, in some embodiments it is contemplated that the sent electronic message can be saved in either or both of the first user account and second user account for future referencing.

In some embodiments, it is contemplated that the first user does not only desire to know when the electronic communication is automatically sent to the second user, but also whether the electronic communication has been opened by the second user and displayed on the second user device. Accordingly, it is contemplated that a confirmation message can be automatically sent to the first user device through the central distribution server over the electronic communication network once the electronic message has been opened by the second user.

In some embodiments, it is contemplated that if the predetermined delivery criterion has not been satisfied, an electronic prompt message can be automatically sent from the central distribution server to the first user through the electronic communication network.

It is further contemplated that the electronic prompt message can contain a number of mechanisms where by the first user can determine how it wishes to proceed with the delivery of the electronic communication. In some embodiments, it is contemplated that the first user has the option to cancel the delivery of the electronic message, regardless of the satisfaction of the predetermined delivery criterion.

In other embodiments, the first user may be prompted to send an electronic hint message to the second user through the electronic communication network. In other embodiments, it is contemplated the first user can autonomously generate and send a hint message without prompting from the central distribution server. Moreover, in some embodiments it is contemplated that the hint message can include hint information that corresponds to the predetermined delivery criterion and selected by the first user.

It is contemplated that hint information can include any suitable information that corresponds to the predetermined delivery criterion, including a text string that is a question (“The location of our first date” or “Your favourite sandwich shop”), a geographic location that can be represented on a map accessible through the user account, a photograph, video or audio recording or any other suitable hint information that corresponds to the predetermined delivery criterion.

In some embodiments, it is contemplated that a geographic location is associated with the electronic message once it has been automatically sent to the second user device through the central distribution server over the electronic communication network. It is contemplated that the geographic location corresponds to the actual geographic location of the second user device when the electronic communication is automatically sent to the second user device. In some embodiments, it is also contemplated that the geographic location corresponds to the actual geographic location of the second user device when the electronic communication is opened by the second user and displayed on the second user device.

Therefore, it is contemplated that a user of the present method and system can populate a geographic map (which can be associated with and accessible via that user's account) that visually displays the geographic locations that correspond to each electronic communication that has been received (or, in other embodiments, opened or displayed) by that particular user of the present methods and systems.

In this way, a first user can create a first user account on the central distribution server and send invites to other potential users (either through traditional electronic messages or social networking connections) to use the present method and system.

Once a second user has created a second user account on the central distribution server, the authenticated first user can compose and send an electronic communication having at least one predetermined delivery criterion to the second user.

In the period before the predetermined delivery criterion is satisfied, the central distribution server stores the electronic communication in a database and the first user can access the stored electronic communication through the first user account. If the predetermined delivery criterion is not satisfied over a specified time period, it is contemplated that the first user can send an optional hint message to the second user to encourage satisfaction of the predetermined delivery criterion.

Once the predetermined delivery criterion is satisfied, it is contemplated that the electronic message can be automatically sent to the second user device and, optionally a confirmation message can be automatically sent to the first user device that the electronic message has been automatically sent to the second user device. Moreover, it is contemplated that an optional confirmation message can be automatically sent to the first user device when the electronic communication is opened by the second user and/or displayed on the second user device.

Finally, it is contemplated that a geographic location that corresponds to the geographic location of the second user device when the electronic communication is received (or, opened and displayed) by the second user device can be associated with the sent electronic communication, and a visual map can be populated with these geographic locations. In this way, a user of the present methods and systems can access this visual map by way of the respective user account, and a visual representation of all electronic communications that the user has sent, received, opened and/or displayed can be displayed in a visual format.

User-to-User Networked Messaging with Targeted Promotion

In some embodiments, it is contemplated that the electronic communication can further include a targeted promotion, such that the second user will receive the targeted promotion when the predetermined delivery criterion is met and the electronic communication is automatically sent to the second user device.

It is contemplated that the “targeted promotion” can take a number of forms, including but not limited to a commercial offer in any suitable form, a traditional coupon attached as an electronic document, a scannable code that can be redeemed at a point of sale, an encoded text string that can be used in an e-commerce context, a hyperlink that can be used in an e-commerce context or reward points or a cash amount that can be deposited in the second user account or a third-party account.

It is contemplated that the first user can select the promotion from a plurality of available promotions that are made available to the first user device through the central distribution server over the electronic communication network. In some embodiments, it is contemplated that the plurality of available promotions is selected from a promotions database and that the plurality of available promotions can be selected based on the at least one predetermined delivery criterion that has been selected by the first user. It is further contemplated that the promotions database can be populated with promotions that are each associated with a particular merchant user.

In some embodiments, it is contemplated that promotions can be selected by a search of the promotion database performed by the first user. For example, the first user may search based on a merchant member, a geographic location, a promotion category or any other suitable search parameter that can be used to sort and retrieve suitable promotions from the database.

In this way, it is contemplated that the first user can automatically send the second user an electronic communication that includes at least one delivery criterion and that further includes a targeted promotion. The electronic communication is stored in a database on the central distribution server and once the predetermined delivery criterion is satisfied the electronic communication is automatically sent to the second user device. Once the electronic communication is received and opened by the second user, the second user can subsequently redeem the targeted promotion as a gift given and sent by the first user.

Computing Environment

It is contemplated that the user devices and central distribution servers described herein may be any suitable computing device or network node and may include any type of electronic computing device, including but not limited to, mobile devices such as smartphones or cellular telephones.

Examples can further include fixed or mobile user equipment, such as internet of things (IoT) devices, endpoints, home automation devices, medical equipment in hospital or home environments, inventory tracking devices, environmental monitoring devices, energy management devices, infrastructure management devices, vehicles or devices for vehicles, fixed electronic devices, among others. Vehicles includes motor vehicles (e.g., automobiles, cars, trucks, buses, motorcycles, etc.), aircraft (e.g., airplanes, unmanned aerial vehicles, unmanned aircraft systems, drones, helicopters, etc.), spacecraft (e.g., spaceplanes, space shuttles, space capsules, space stations, satellites, etc.), watercraft (e.g., ships, boats, hovercraft, submarines, etc.), railed vehicles (e.g., trains and trams, etc.), and other types of vehicles including any combinations of any of the foregoing, whether currently existing or after arising.

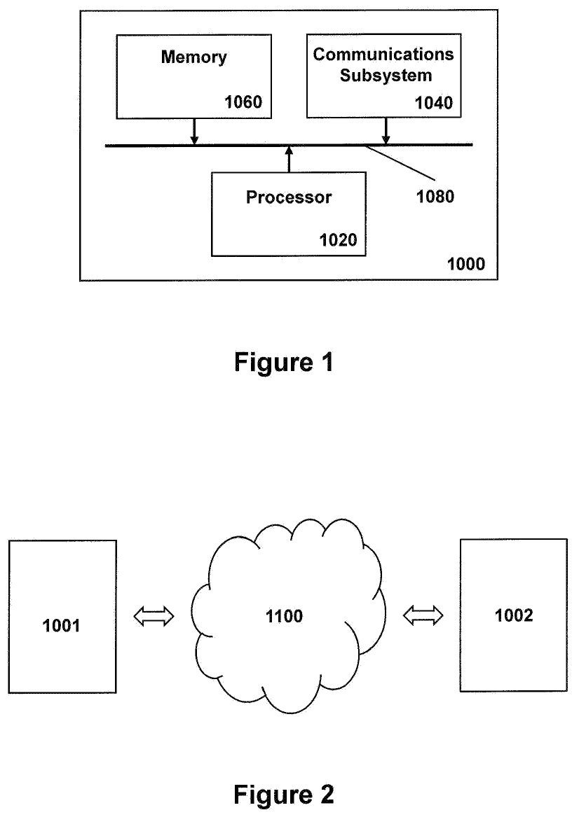

One simplified diagram of a suitable user device for use in connection with the present methods and systems is shown at FIG. 1. It will also be appreciated that the user device of FIG. 1 could be any UE, S-CSCF, P-CSCF, I-CSCF, TURN server, STUN server, AS, or other node as discussed herein.

In FIG. 1, device 1000 includes a processor 1020 and a communications subsystem 1040, where the processor 1020 and communications subsystem 1040 cooperate to perform the methods of the embodiments described above. Communications subsystem 1040 may, in some embodiments, comprise multiple subsystems, for example for different radio technologies.

It will be understood that processor 1020 is configured to execute programmable logic, which may be stored, along with data, on device 1000, and shown in the example of FIG. 1 as memory 1060. Memory 1060 can be any tangible, non-transitory computer readable storage medium. The computer readable storage medium may be a tangible or in transitory/non-transitory medium such as optical (e.g., CD, DVD, etc.), magnetic (e.g., tape), flash drive, hard drive, or any other suitable other memory known in the art.

Alternatively, or in addition to memory 1060, device 1000 may access data or programmable logic from an external storage medium, for example through communications subsystem 1040.

Communications subsystem 1040 allows device 1000 to communicate with other devices or network elements and may vary based on the type of communication being performed. Further, communications subsystem 1040 may comprise a plurality of communications technologies, including any suitable wired or wireless communications technologies.

In at least one embodiment, communications between the various elements of device 1000 may be through an internal bus 1080. However, it will be readily appreciated that other forms of communication are possible.

In at least one embodiment, communications subsystem 1040 allows device 1000 to communicate with other devices or network elements through a central distribution server over an electronic communication network. Communications subsystem 1040 may use one or more of a variety of communications types, including but not limited to cellular, satellite, Bluetooth™, Bluetooth™ Low Energy, Wi-Fi, wireless local area network (WLAN), near field communications (NFC), ZigBee, wired connections such as Ethernet or fiber, among any other suitable options that will be readily appreciated by the skilled person.

As such, a communications subsystem 1040 for wireless communications will typically have one or more receivers and transmitters, as well as associated components such as one or more antenna elements, local oscillators (LOs), and may include a processing module such as a digital signal processor (DSP). As will be readily apparent to those skilled in the field of communications, the particular design of the communication subsystem 1040 will be dependent upon the electronic communication network or communication technology on which the sensor apparatus is intended to operate.

If communications subsystem 1040 operates over a cellular connection, a subscriber identity module (SIM) may be provided to allow such communications. It is contemplated that a SIM may be a physical card or may be virtual. In some embodiments, a SIM may also be referred to as a universal subscriber identity module (USIM), as merely an identity module (IM), or as an embedded Universal Integrated Circuit Card (eUICC), among other options.

With reference to FIG. 2, a diagram of a first user device 1001 in electronic communication with an analogous second device 1002 over an electronic communication network 1100 is shown. As discussed herein, it is contemplated that first user device and second user device are analogous to user device 1000 discussed above, and that electronic communication network 1100 can take a variety of forms as discussed herein. For example, first user device 1001 can be in electronic communication with an analogous second device 1002 by way of near field communication (NFC) protocols or alternatively may be in electronic communication through a fixed or wireless link through a central distribution server, such as the internet.

### EXAMPLE 1

### User-to-User Networked Messaging

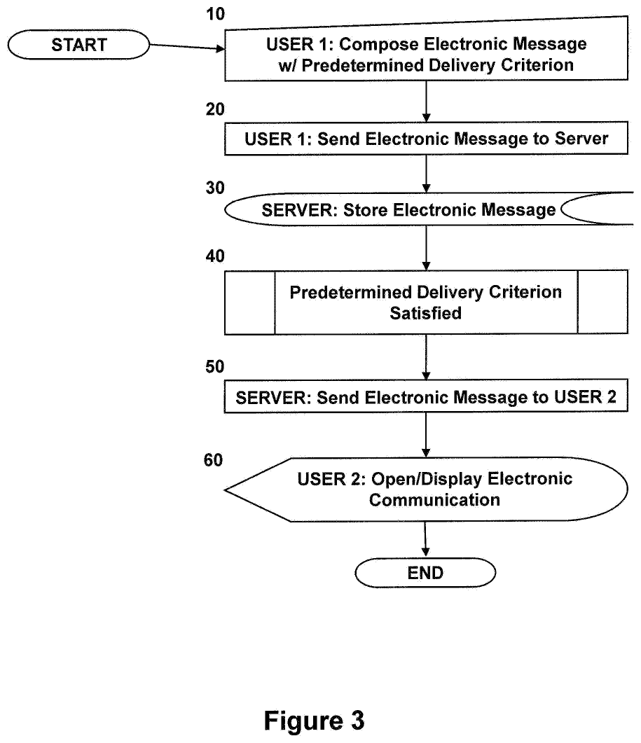

With reference to FIG. 3, a diagram of at least one embodiment of a method adapted for sending electronic communications over an electronic communication network through a central distribution server is shown.

In this embodiment, a first user and a second user are suitably connected over the electronic communication network through a central distribution server. Next, it is contemplated that the first user can compose a suitable electronic message 10 for automatically sending to the second user over the electronic communication network through the central distribution server.

It is contemplated that an electronic communication includes at least one predetermined delivery criterion. As discussed herein, it is contemplated that the predetermined delivery criterion can take a number of forms and that the electronic communication will be automatically sent to the second user device upon satisfaction of the at least one predetermined delivery criterion. In this embodiment the at least one predetermined delivery criterion is a date (i.e: Jul. 1, 2030).

In the intervening period before the electronic communication is automatically sent to the second user device upon satisfaction of the predetermined delivery criterion, it is contemplated that the electronic communication is first sent to the central distribution server 20 from the first user device and is stored in a database hosted by the central distribution server 30. It is further contemplated that the first user can track, access and edit the stored electronic communication during this period through the associated first user account.

Once the predetermined delivery criterion is satisfied 40 (i.e. the selected date, Jul. 1, 2030, has arrived), it is next contemplated that the electronic communication is automatically sent to the second user device 50 through the central distribution server over the electronic communication network. Now, the second user can open and display the electronic communication 60 on the second user device.

In this way, it is contemplated that the first user can send the second user an electronic communication that is stored with the central distribution server until a predetermined delivery criterion is satisfied, at which point the electronic communication is automatically sent to the second user.

### EXAMPLE 2

### User-to-User Networked Messaging

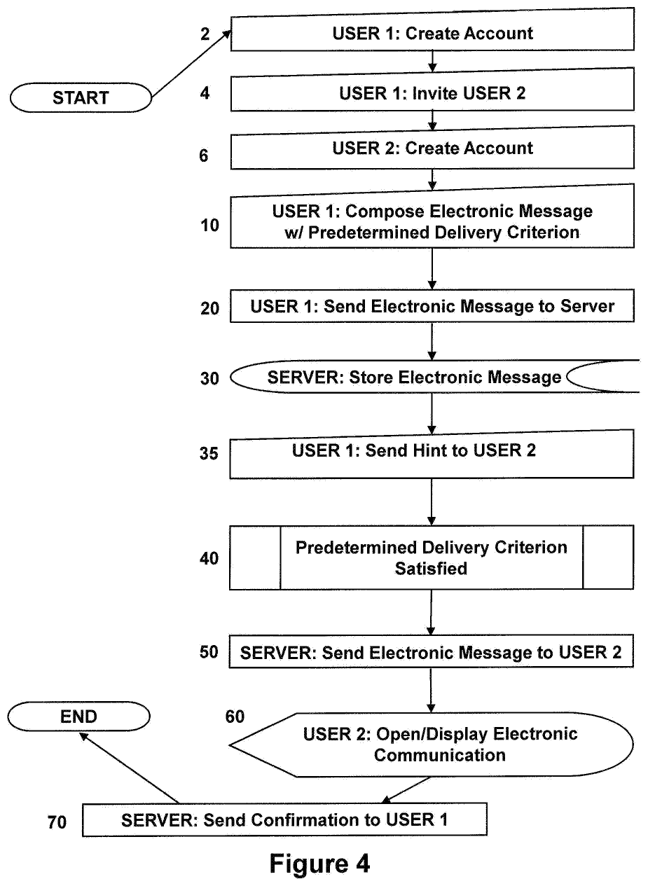

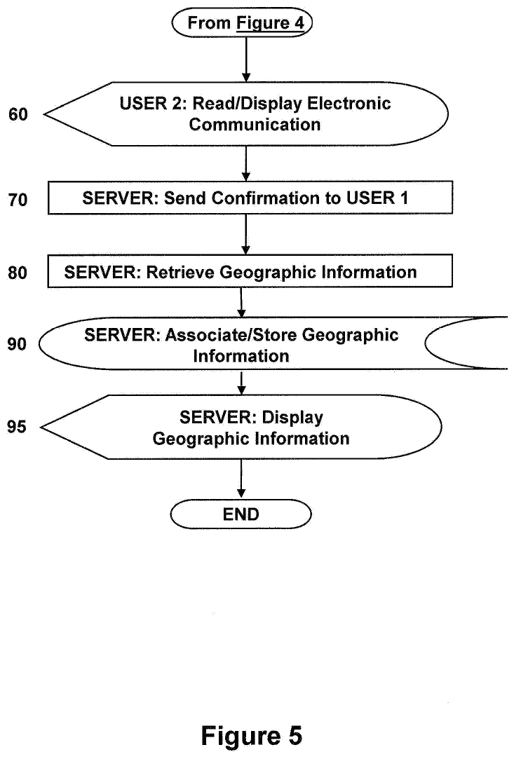

With reference to FIG. 4, a diagram of another embodiment of a method adapted for sending electronic communications over an electronic communication network through a central distribution server is shown.

In this embodiment, the present method is initiated when a first user creates a first user account 2 by accessing a database hosted on the central distribution server through a first user device over an electronic communication network.

The first user account can include a variety of information associated with the first user including personal identification information and data, passwords, banking information and account information obtained from an associated social network account (such as but not limited to Facebook®, Twitter®, LinkedIn® and Gmail®). In some embodiments it is contemplated that a user account can include contact information for other current and potential social network users.

After the first user account has been created 2, it is contemplated that the first user can invite a second user who the first user wishes to communicate with over the electronic communication network 4. In this embodiment, it is contemplated that an invitation is sent directly from the first user device to a second user over the electronic communication network by way of an email, although other methods of communication are also contemplated including a text message.

In other embodiments, it is also contemplated that suitable contact information can be directly imported into the first user's account based on a pre-existing social media account, such as but not limited to Facebook®, Twitter®, LinkedIn® and Gmail® and the user's personal contact list obtained from the user's mobile device.

In this embodiment, it is contemplated that once the second user has been invited to connect with first user over the electronic communication network through a central distribution server 4, the second user creates a second user account 6 by accessing a database hosted on the central distribution server through a second user device over an electronic communication network.

Once the first user and the second user are suitably connected over the electronic communication network through the central distribution server, it is contemplated that the first user can compose a suitable electronic message for sending to the second user over the electronic communication network through the central distribution server 10.

It is contemplated that an electronic communication is associated with at least one predetermined delivery criterion. In this embodiment, it is contemplated that the predetermined delivery criterion is a geolocation-based delivery criteria (i.e. a specific geographic location such as a particular coffee shop) and that the electronic communication will be automatically sent to the second user device upon satisfaction of the at least one predetermined delivery criterion.

In the intervening period before the electronic communication is automatically sent to the second user device upon satisfaction of the predetermined delivery criterion, it is contemplated that the electronic communication is sent to the central distribution server 20 from the first user device and stored in a database hosted by the central distribution server 30. It is further contemplated that the first user can track, access and edit the stored electronic communication during this period through the associated first user account.

In this embodiment, it is contemplated that before the predetermined delivery criterion has been satisfied, an electronic prompt message is automatically sent from the central distribution server to the first user through the electronic communication network.

In some embodiments, tt is further contemplated that the electronic prompt message can contain a prompt to send an electronic hint message to the second user through the electronic communication network 35. In other embodiments, it is contemplated that the hint message can be autonomously generated and sent by the first user from the first user device. In this embodiment, it is contemplated that the hint message can include hint information that corresponds to the predetermined delivery criterion and selected by the first user. In this embodiment, a suitable hint could be: “The location of our first date”, however it will be understood that any suitable hint information that corresponds to the predetermined criterion is contemplated.

Once the predetermined delivery criterion is satisfied 40 (i.e.: the second user visits the particular coffee shop), it is next contemplated that the electronic communication is automatically sent to the second user device through the central distribution server over the electronic communication network 50.

Once the electronic message is automatically sent 50 and the second user opens the electronic communication and displays it on second user device 60, in some embodiments it is contemplated that a confirmation message is automatically sent to the first user device through the central distribution server over the electronic communication network 70. Moreover, in some embodiments it is contemplated that the automatically sent electronic message can be saved in either or both of the first user account and second user account for future referencing.

In some embodiments, it is contemplated that the first user does not only desire to know when the electronic communication is automatically sent to the second user, but also whether the electronic communication has been opened by the second user and displayed on the second user device. Accordingly, it is contemplated that a confirmation message can be automatically sent to the first user device through the central distribution server over the electronic communication network once the electronic message has been opened by the second user 70.

In this way, a first user can create a first user account on the central distribution server and send invites to another potential user through (a traditional email) to use the present method and system.

Once the second user has created a second user account on the central distribution server, the authenticated first user can compose and send an electronic communication having at least one predetermined delivery criterion to the second user.

In the period before the predetermined delivery criterion is satisfied, the central distribution server stores the electronic communication in a database and the first user can access the stored electronic communication through the first user account. If the predetermined delivery criterion is not satisfied over a specified time period, it is contemplated that the first user can send a hint message to the second user to encourage satisfaction of the predetermined delivery criterion.

Once the predetermined delivery criterion is satisfied, it is contemplated that the electronic message can be automatically sent to the second user device and a confirmation message can be automatically sent to the first user device that the electronic message has been automatically sent to the second user device.

Moreover, in some embodiments it is contemplated that a confirmation message can be automatically sent to the first user device when the electronic communication is opened by the second user and displayed on the second user device.

### EXAMPLE 3

### User-to-User Networked Messaging with Geographic Tracking

With reference to FIG. 5, in this embodiment it is contemplated that a geographic location is associated with the electronic message 80 after it has been sent to the second user device through the central distribution server over the electronic communication network. In this embodiment, it is contemplated that the geographic location corresponds to the actual geographic location of the second user device when the electronic communication was automatically sent to the second user device.

Therefore, it is contemplated that the central distribution server stores the geographic information in connection with the user account 90 and populates a geographic visual map and displays the geographic locations that correspond to each electronic communication that has been received (or, in other embodiments, automatically sent and/or opened) by that particular user 95 of the present methods and systems.

As a result, it is contemplated that a geographic location that corresponds to the geographic location of the second user device when the electronic communication is sent or received (or, opened and/or displayed) by the second user device can be associated with the automatically sent electronic communication 90, and a visual map can be populated with these geographic locations in order to provide a visual display of this geographic information 95. In this way, a user of the present methods and systems can access this visual map by way of the respective user account, and a visual representation of all electronic communications that the user has automatically sent, received, opened and/or displayed can be displayed in a visual format on a geographic map readily accessible through the user's account.

### EXAMPLE 4

### User-to-User Networked Messaging with Targeted Promotion

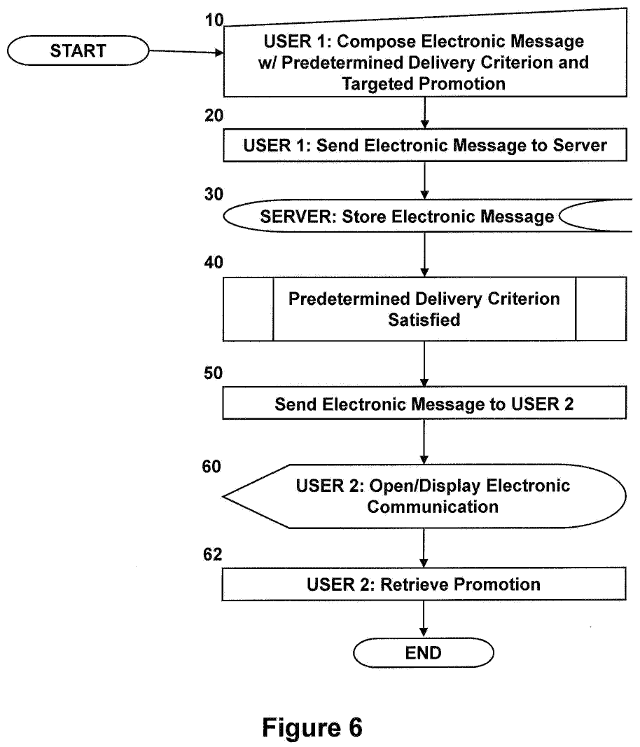

With reference to FIG. 6, a diagram of another embodiment of a method adapted for sending electronic communications over an electronic communication network through a central distribution server is shown.

In this embodiment, a first user and a second user are suitably connected over the electronic communication network through a central distribution server. Next, it is contemplated that the first user can compose a suitable electronic message 10 for sending to the second user over the electronic communication network through the central distribution server.

It is contemplated that an electronic communication includes at least one predetermined delivery criterion. As discussed herein, it is contemplated that the predetermined delivery criterion can take a number of forms and that the electronic communication will be automatically sent to the second user device upon satisfaction of the at least one predetermined delivery criterion. In this embodiment the at least one predetermined delivery criterion is a date (such as the second user's birthday).

In this embodiment, it is further contemplated that the electronic communication further includes a targeted promotion, such that the second user will receive the targeted promotion when the predetermined delivery criterion is met and the electronic communication is automatically sent to the second user device.

It is contemplated that the “targeted promotion” can take a number of forms, and in this embodiment is a scannable QR code for a free session at a day spa.

It is contemplated that the first user selects the promotion based on a targeted search of a plurality of available promotions that are made available to the first user device through the central distribution server over the electronic communication network.

In the intervening period before the electronic communication is automatically sent to the second user device upon satisfaction of the predetermined delivery criterion, it is contemplated that the electronic communication is first sent to the central distribution server 20 from the first user device and is stored in a database hosted by the central distribution server 30. It is further contemplated that the first user can track, access and edit the stored electronic communication during this period through the associated first user account.

Once the predetermined delivery criterion is satisfied 40 (i.e. the selected date has arrived), it is next contemplated that the electronic communication is automatically sent to the second user device 50 through the central distribution server over the electronic communication network. Now, the second user can open and display the electronic communication 60 on the second user device, and the second user can retrieve the promotion 62.

In this way, it is contemplated that the first user can send the second user an electronic communication that includes at least one delivery criterion and that further includes a targeted promotion. The electronic communication is stored in a database on the central distribution server and once the predetermined delivery criterion is satisfied the electronic communication is automatically sent to the second user device. Once the electronic communication is received and opened by the second user, the second user can subsequently redeem the targeted promotion as a gift given and sent by the first user.

The embodiments described herein are intended to be illustrative of the present compositions and methods and are not intended to limit the scope of the present invention. Various modifications and changes consistent with the description as a whole and which are readily apparent to the person of skill in the art are intended to be included. The appended claims should not be limited by the specific embodiments set forth in the examples, but should be given the broadest interpretation consistent with the description as a whole.

1. A method for sending an electronic communication over an electronic communication network through a central distribution server, the method comprising:
receiving an electronic communication from a first user device, the electronic communication including at least one predetermined delivery criterion and associated with at least a second user device, the at least a second user device associated with a respective at least a second user, the electronic communication sent from a first user device to a database over the electronic communication network, the database hosted on the central distribution server in electronic communication with the first user device over the electronic communication network;
storing the electronic communication in a first user account associated with the first user and stored on the database; and
automatically sending the electronic communication to at least a second user device in electronic communication with the central distribution server over the electronic communication network upon satisfaction of the at least one predetermined delivery criterion.

2. The method of claim 1, further comprising the step of:
storing the electronic communication in at least a second user account associated with the at least a second user and stored on the database.

3. The method of claim 1, wherein the electronic communication further includes a targeted promotion.

4. The method of claim 3, wherein the targeted promotion is selected from a plurality of available promotions, the plurality of available promotions stored in a promotion database, the promotion database hosted with the central distribution server, each of the plurality of available promotions associated with a merchant user.

5. The method of claim 4, wherein the plurality of available promotions is presented to the first user based on the at least one predetermined delivery criterion.

6. The method of any one of claim 1, further comprising the step of:
authenticating at least one of the first user device and the second user device with the central distribution server over the electronic communication network.

7. The method of any one of claim 1, wherein, upon the sending of the electronic communication to the at least a second user device over the electronic communication network, a geographic location is associated with the automatically sent electronic communication, the geographic location corresponding to the at least a second user device's geographic location when the electronic communication is received by the at least a second user device.

8. The method of claim 7, wherein the geographic location is stored in at least one of the first user account and the second user account, the geographic location displayed in a geographic map accessible through the at least one of the first user account and the second user account.

9. The method of any one of claim 1, further comprising the step of:
if the at least one predetermined delivery criterion has not been satisfied, sending a prompt message to the first user device.

10. The method of claim 8, wherein the prompt message includes means for cancelling the electronic communication.

11. The method of claim 9, wherein the prompt message includes means for sending a hint message to the second user device, the hint message including hint information that corresponds to the at least one predetermined delivery criterion and further comprising the step of:
sending the hint message to the second user device.

12. The method of any one of claim 1, further comprising the steps of:
receiving an invitation message from the first user device, the invitation directed to the at least one second user, the invitation message including identification information relating to the at least one user, and
sending the invitation message to the at least one second user device.

13. The method of any one of claim 1, further comprising the steps of:
receiving a hint message from the first user device, the hint message including hint information that corresponds to the at least one predetermined delivery criterion; and
sending the hint message to the second user device.

14. The method of any one of claim 1, further comprising the step of:
automatically sending a confirmation message to the first user device over the electronic communication network upon the sending of the electronic communication to the at least a second user device.
